(19) United States
(12) Patent Application Publication
(10) Pub. No.: US 2021/0338506 A1
(43) Pub. Date: Nov. 4, 2021

(54) SUPPORT SURFACE OVERLAY SYSTEM

(71) Applicant: DABIR SURFACES, INC., Chicago, IL (US)

(72) Inventors: David A. DZIOBA, Frankenmuth, MI (US); Anatoliy NITSA, Buffalo Grove, IL (US); Terry CHUNG, Kildeer, IL (US)

(21) Appl. No.: 17/246,372

(22) Filed: Apr. 30, 2021

Related U.S. Application Data
(60) Provisional application No. 63/017,732, filed on Apr. 30, 2020.

(51) Int. Cl. A61G 7/057

(52) U.S. Cl. CPC A61G 7/05776

(57) ABSTRACT

A support surface overlay system includes a support surface overlay and a control system. The support surface overlay includes a support bladder having first and second alternatingly inflatable compartments, and an envelope defining and interior region surrounding the support bladder. The control system is configured to alternatingly inflate and deflate the first and second alternatingly inflatable compartments, and to concurrently evacuate air from the interior region of the envelope.

### CROSS REFERENCE TO RELATED APPLICATIONS

This application claims the benefit of priority under 35 U.S.C. § 119(e) to U.S. Provisional Patent Application No. 63/017,732, filed Apr. 30, 2020. The disclosures set forth in the referenced applications are incorporated herein by reference in their entireties.

### BACKGROUND OF THE DISCLOSURE

Therapeutic support surface overlays for supporting patients are known in the art. Some such overlays include first and second independently inflatable compartments that may be alternately inflated and deflated so as to alternatingly apply and relieve support pressure to and from the patient's body. By alternatingly applying and relieving support pressure to and from the patient's body, such an overlay much mitigate the formation of, or assist in the treatment of, decubitus ulcers (commonly referred to as pressure ulcers).

Such overlays commonly are provided with control systems including pumps and valves configured to inflate and deflate the first and second inflatable compartments. Such control systems typically vent inflated compartments to atmosphere in order to deflate them, and draw air from the atmosphere in order to inflate deflated compartments. Such control systems can be energy inefficient, and they might not function to fully deflate the inflated compartments, thereby adversely impacting the efficacy of the overlay.

### SUMMARY OF THE DISCLOSURE

A therapeutic support surface overlay system according to the present disclosure may include a therapeutic support surface overlay having a first inflatable compartment, a second inflatable compartment, and an envelope enclosing the first and second inflatable compartments, wherein the first inflatable compartment defines a first variable air volume, the second inflatable compartment defines a second variable air volume separate from and independent of the first variable air volume, and the envelope defines a third variable air volume separate from and independent of the first variable air volume and the second variable air volume.

A therapeutic support surface overlay system according to the present disclosure may also include a control system for use with the support surface overlay. The control system may include: a pneumatic pump having a pump inlet port and a pump outlet port; a first three-way control valve having a first port fluidly coupled to the pump inlet port, a second port configured to be fluidly coupled to the first variable air volume, and a third port coupled to the pump outlet port; a second three-way control valve having a first port fluidly coupled to the pump inlet port, a second port configured to be fluidly coupled to the second variable air volume, and a third port coupled to the pump outlet port; and an inlet flow control device having a first port fluidly coupled to an environment external to the control system and a second port fluidly coupled to the pump inlet port.

The control system is configured to selectively and alternatingly inflate and deflate the first and second inflatable compartments and to concurrently evacuate fluid from an uninflated one of the first and second inflatable compartments.

In some embodiments, the control system may include an envelope suction port configured for fluid connection to the third variable air volume. In such embodiments, the control system may be configured to evacuate fluid from the envelope as well as from the uninflated one of the first and second inflatable compartments.

In other embodiments, the therapeutic support surface overlay system may include any combination of features as described further herein.

These and other features of the present disclosure will become more apparent from the following description of illustrative embodiments.

### BRIEF DESCRIPTION OF THE DRAWINGS

FIG. 1 is a top is a top plan view of an illustrative therapeutic support surface overlay for use in a system according to the present disclosure, the support surface overlay including a bladder disposed within an interior region of an envelope, wherein the bladder includes first and second sheets joined together by a seam to thereby define first and second selectively and independently inflatable compartments, and wherein the envelope includes first and second panels and a seam joining the first and second panels to the bladder;

FIG. 2 is a bottom plan view of the support surface overlay of FIG. 1;

FIG. 3 is a cross-sectional view of the support surface overlay of FIG. 1;

FIG. 4 is a detail view of a portion of the support surface overlay of FIG. 1;

FIG. 5 is a side elevation view of the support surface overlay system of FIG. 1;

FIG. 6 is a partial top plan view of the support surface overlay of FIG. 1 according to the present disclosure, showing some of the features thereof in greater detail;

FIG. 7 is a schematic diagram of an illustrative support surface overlay system according to the present disclosure in a first operational state, the system including the support surface overlay of FIGS. 1-6 and a pneumatic control system, wherein the pneumatic control system is configured to selectively pressurize the first and second inflatable compartments of the bladder, and to selectively withdraw air from the interior region of the envelope of the support surface overlay;

FIG. 7A is a schematic diagram of an alternative form of inlet flow controller for the pneumatic control system of FIG. 7;

FIG. 7B is a schematic diagram of another alternative form of inlet flow controller for the pneumatic control system of FIG. 7;

FIG. 7C is a schematic diagram of a further alternative form of inlet flow controller for the pneumatic control system of FIG. 7;

FIG. 8 is a schematic diagram of the illustrative support surface overlay system in a second operational state;

FIG. 9 is a schematic diagram of the illustrative support surface overlay system in a third operational state;

FIG. 10 is a schematic diagram of the illustrative support surface overlay system in a fourth operational state;

FIG. 11 is a schematic diagram of the illustrative support surface overlay system in a fifth operational state;

FIG. 12 is a schematic diagram of the illustrative support surface overlay system in a sixth operational state;

FIG. 13 is a schematic diagram of the illustrative support surface overlay system in a seventh operational state;

FIG. 14 is a schematic diagram of the illustrative support surface overlay system in an eighth operational state;

FIG. 15 is a schematic diagram of the illustrative support surface overlay system in a ninth operational state;

FIG. 16 is a schematic diagram of the illustrative support surface overlay system in a tenth operational state;

FIG. 17 is a schematic diagram of the illustrative support surface overlay system in an eleventh operational state;

FIG. 18 is a schematic diagram of the illustrative support surface overlay system in a twelfth operational state;

FIG. 19 is a schematic diagram of the illustrative support surface overlay system in a thirteenth operational state;

FIG. 20 is a schematic diagram of the illustrative support surface overlay system in an fourteenth operational state;

FIG. 21 is a schematic diagram of the illustrative support surface overlay system in a fifteenth operational state; and

FIG. 22 is a flowchart showing an illustrative method of operating a support surface overlay according to the present disclosure.

### DETAILED DESCRIPTION OF THE DRAWINGS

For the purposes of promoting an understanding of the disclosure, one or more illustrative embodiments shown in the drawings and variations thereof will now be described in detail.

As used herein, and as would be recognized by one skilled in the art, the phrase “aligned with” means “fluidly coupled to” or “in fluid communication with” or the like. Similarly, the term “isolated” as used herein means “not aligned with” or “not fluidly coupled to” or “not in fluid communication with.”

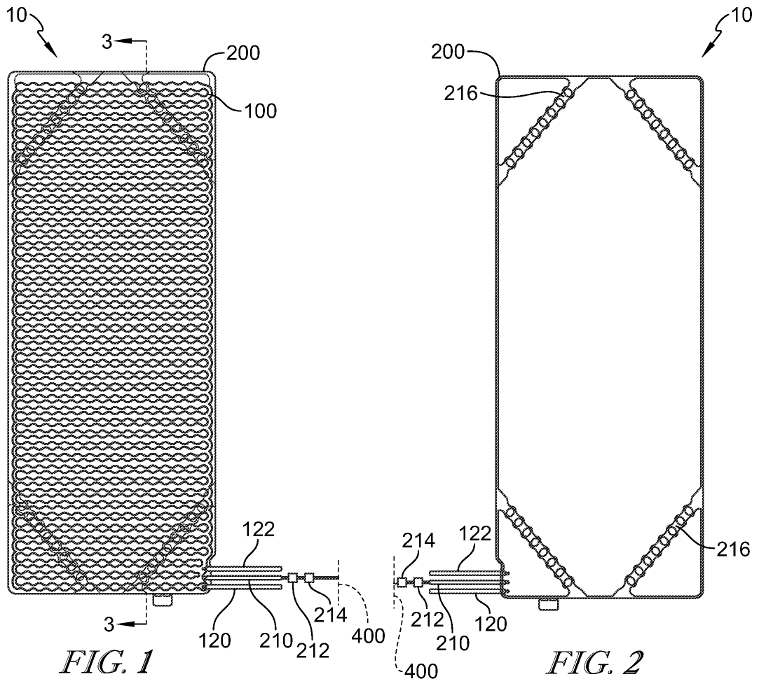

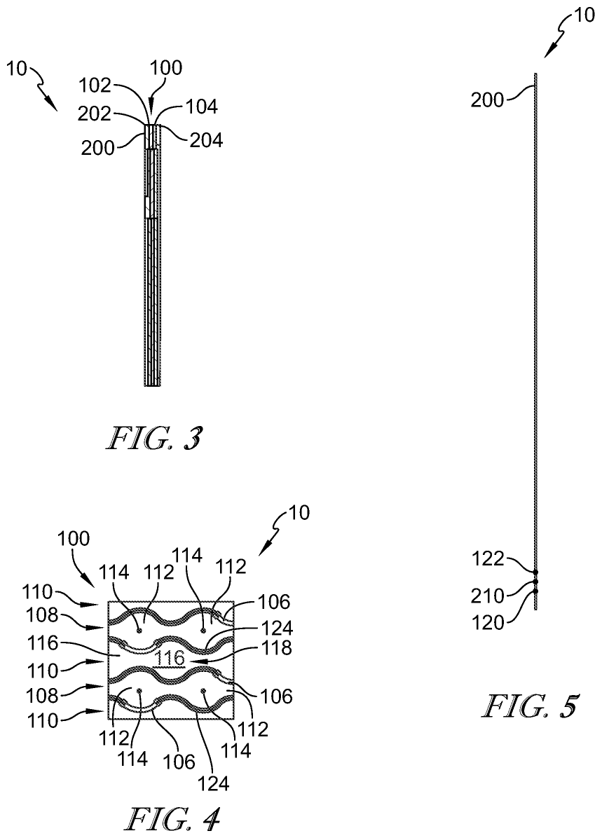

FIGS. 1-6 show an illustrative support surface overlay 10 including an illustrative support bladder 100 disposed within an illustrative envelope 200. The bladder 100 includes a first (or upper) flat, flexible sheet 102 overlying a second (or lower) flat, flexible sheet 104. One or both of the first and second sheets 102, 104 may be imperforate. The first and second sheets 102, 104 are joined together by a generally sinusoidal seam 106, thereby defining first and second interdigitated inflatable compartments 108, 110. The first inflatable compartment 108 defines a first variable air volume Z1, and the second inflatable compartment defines a second variable air volume Z2 separate from and independent of the first variable air volume Z1. As best shown in FIG. 4, the seam 106 may define one or more relief cuts 124, for example, as further described in U.S. Pat. No. 9,216,122, the disclosure of which is incorporated by reference herein.

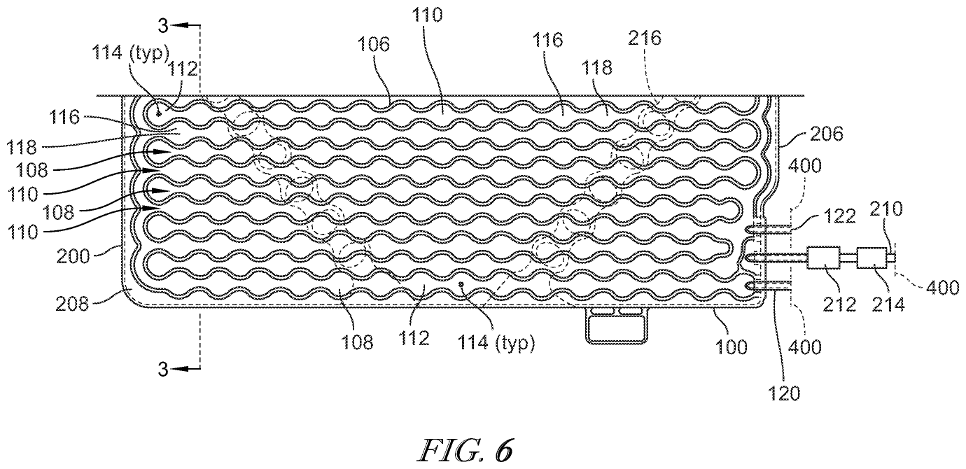

The first and second compartments 108, 110 may be selectively and independently inflated and deflated. The first compartment 108 may define a first plurality of inflatable cells 112 arranged in rows, each of the first plurality of inflatable cells 112 defining a corresponding contact node 114 when inflated. The second compartment 110 may define a second plurality of inflatable cells 116 arranged in rows interdigitated with the rows of the first plurality of inflatable cells 112, each of the second of inflatable cells 116 defining a corresponding contact node 118 when inflated. As best shown in FIGS. 1 and 6, the rows of first and second inflatable cells 114, 116 may extend in a side-to-side direction of the bladder 100. In other embodiments, the rows of first and second inflatable cells 114, 116 may extend in an end-to-end direction of the bladder 100, perpendicular to that shown. In further embodiments, the rows of first and second inflatable cells 114, 116 could extend in other directions.

In other embodiments, the bladder 100 could take any number of alternative forms.

A first bladder tube 120 defining a lumen therethrough extends from the first compartment 108 in fluid communication therewith. A second bladder tube 122 defining a lumen therethrough extends from the second compartment 110 in fluid communication therewith. The first and second bladder tubes 120, 122 are joined or otherwise connected to one or both of the first and second sheets 102, 104 in sealed engagement therewith. The free ends of the first and second bladder tubes 120, 122 are configured for connection to the control system 300, for example, via an intervening connector 400, as will be discussed further below.

The envelope 200 includes a first (or upper) flexible panel 202 overlying a second (or lower) flexible panel 204. One or both of the first and second panels 202, 204 are flat and imperforate. In some embodiments, the first and second panels 202, 204 may be configured so that the first panel 202 stretches elastically to a greater degree than does the second panel 204 when the first panel 202 and the second panel 204 are subjected to the same or similar tensile load, as will be discussed further below. In an embodiment, the first panel 202 is substantially thinner than the second panel 204, for example, half the thickness of the second panel, so that the first panel 202 stretches elastically to a greater degree than does the second panel 204 when the first panel 202 and the second panel 204 are subjected to the same or similar tensile loads. The first and second panels 202, 204 are joined together by a generally circumferential seam 206, thereby defining an interior region 208 of the envelope and a third variable air volume Z3 separate from and independent of the first and second variable air volumes Z1, Z2. In other embodiments, the envelope 200 could take any number of alternative forms.

An envelope tube 210 defining a lumen therethrough extends from the interior region 208 in fluid communication therewith. The envelope tube 210 is joined or otherwise connected to either or both of the first and second panels 202, 204 in sealed engagement therewith. The envelope tube 210 includes an optional in-line envelope filter 212 configured to capture biohazardous material that may be present in the interior region 208 of the envelope 200 and mitigate a likelihood of such biohazardous material from contaminating the controller 300. The envelope tube 210 also includes an in-line calibrated envelope check valve 214 configured to preclude undesired entry of air from atmosphere to the interior region 208 of the envelope 200. The free end of the envelope tube 210 is configured for connection to the control system 300, for example, via an intervening connector 400, as will be discussed further below. As shown, the in-line calibrated envelope check valve 214 is outboard of the optional in-line envelope filter 212, and both the in-line calibrated envelope check valve 214 and the optional in-line envelope filter 212 are outside the envelope 200. In embodiments, the in-line calibrated envelope check valve 214 may be inboard of the optional in-line envelope filter 212, and either or both of the in-line calibrated envelope check valve 214 and the optional in-line envelope filter 212 may be inside the envelope 200. In embodiments, the optional in-line envelope filter 212 could be integrated into the connector 400.

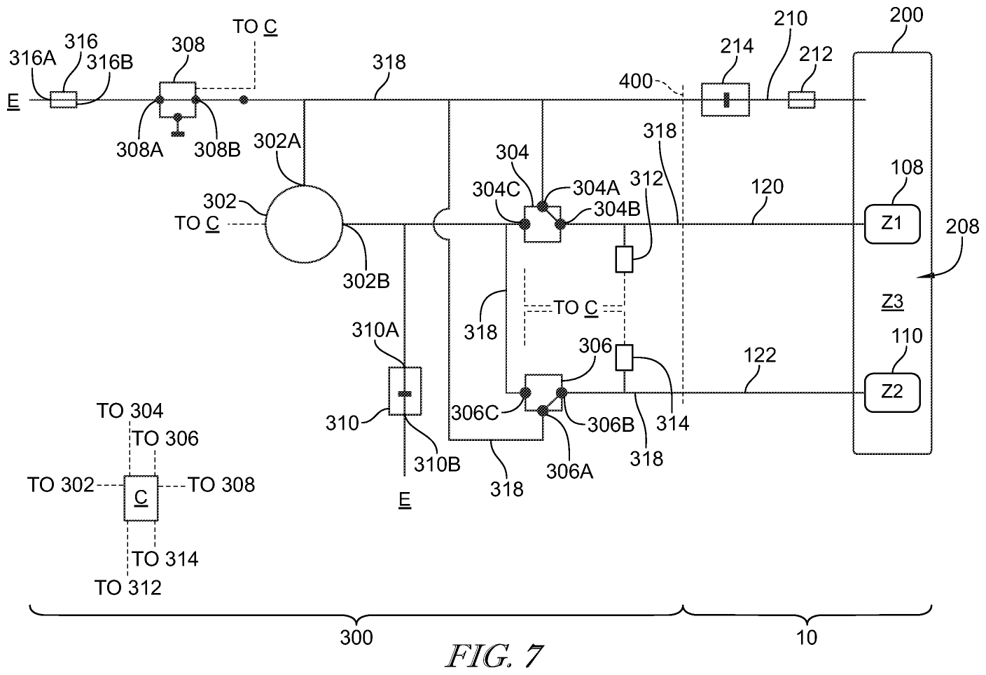

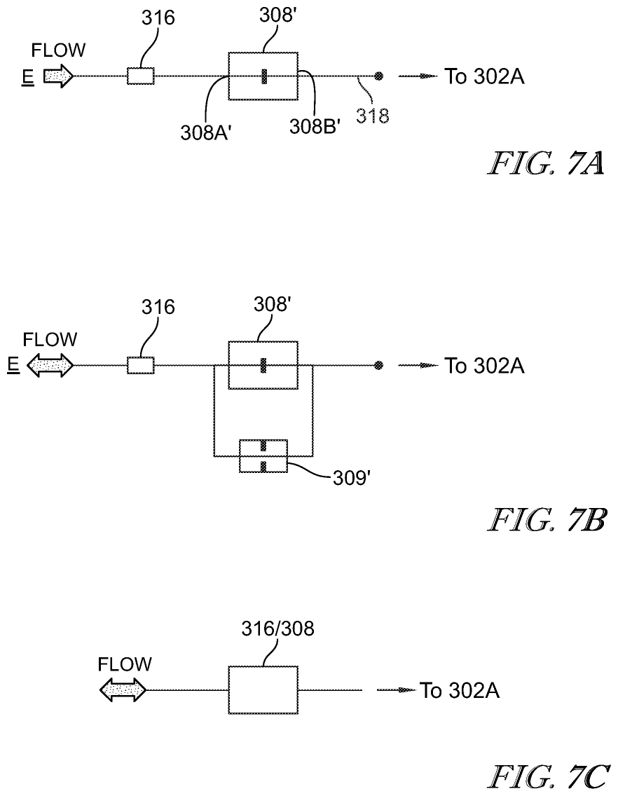

FIGS. 7-21 show an illustrative pneumatic control system 300 for use with the illustrative support surface overlay 10 in various operational states. The control system 300 operable to selectively and independently force pressurized air (or another medium) into, and relieve air (or another medium) from, the first and second variable air volumes Z1, Z2 defined by the first and second inflatable compartments 108, 110, respectively, to thereby selectively and independently inflate and deflate the corresponding inflatable cells 112, 116 through the first and second bladder tubes 120, 122. The control system 300 also is operable to selectively withdraw (or evacuate) air (or another medium) from the third variable air volume Z3 defined by the interior region 208 of the envelope 200 to thereby selectively collapse the first and second panels 202, 204 of the envelope 200 against the first and second sheets 102, 104 of the bladder 100 within the envelope 200.

The control system 300 includes a pneumatic pump 302, a first three-way control valve 304, and a second three-way control valve 306. In the embodiment shown, the control system 300 also includes an inlet flow controller 308, a pressure relief valve 310, a first pressure sensor 312, a second pressure sensor 314, an inlet filter 316, and a controller C. The control system 300 further includes fluid conduits 318 connecting the pneumatic pump 302, the first three-way control valve 304, the second three-way control valve 306, the inlet flow controller 308, the pressure relief valve 310, the first pressure sensor 312, the second pressure sensor 314, and the inlet filter 316 in fluid communication with each other, as will be discussed further below.

In some embodiments, any or all of the pressure relief valve 310, the first pressure sensor 312, the second pressure sensor 314, and the inlet filter 316 could be omitted.

The pneumatic pump 302 includes a pump inlet port 302A and a pump outlet port 302B. The pump inlet port 302A may be selectively fluidly coupled to a source of air or other fluid to be pressurized by the pump 302, as will be discussed further below. For example, the pump inlet port 302A may be selectively fluidly coupled to one or more of an environment E surrounding the control system 300, the first variable air volume Z1, and the second variable air volume Z2, as will be discussed further below. The pump outlet port 302B may be selectively fluidly coupled to the first variable air volume Z1 defined by the first inflatable compartment 108 and to the second variable air volume Z2 defined by the second inflatable compartment 110. The pump 302 also includes an electric motor electrically coupled to the controller C.

The first three-way control valve 304 includes a first port 304A fluidly coupled to the pump inlet port 302A, a second port 304B configured to be fluidly coupled to the first variable air volume Z1 defined by the first inflatable compartment 108, and a third port 304C fluidly coupled to the pump outlet port 302B. As shown, the first three-way flow control valve 304 may be embodied as a solenoid-operated valve having its solenoid electrically coupled to the controller C. In some such embodiments, the first three-way flow control valve 304 may be configured so that: (a) the first port 304A is aligned with the second port 304B, and the third port 304 C is isolated from the first port 304A and the second port 304B, when the solenoid is de-energized; and (b) the second port 304B is aligned with the third port 304C, and the first port 304A is isolated from the second port 304B and the third port 304C, when the solenoid is energized.

The second three-way control valve 306 includes a first port 306A fluidly coupled to the pump inlet port 302A, a second port 306B configured to be fluidly coupled to the second variable air volume Z2 defined by the second inflatable compartment 110, and a third port 306C fluidly coupled to the pump outlet port 302B. As shown, the second three-way flow control valves 306 may be embodied as a solenoid-operated valve having its solenoid electrically coupled to the controller C. In some such embodiments, the second three-way flow control valve 306 may be configured so that: (a) the first port 306A is aligned with the second port 306B, and the third port 306C is isolated from the first port 306A and the second port 306B, when the solenoid is de-energized; and (b) the second port 306B is aligned with the third port 306C, and the first port 306A is isolated from the second port 306B and the third port 306C, when the solenoid is energized.

The inlet flow controller 308 includes an inlet port 308A fluidly coupled to the environment E and an outlet port 308B fluidly coupled to the pump inlet port 302A. As shown, the inlet flow controller 308 may be embodied as a two-way control valve. Accordingly, with reference to the illustrated embodiment, the inlet flow controller 308 may be referred to herein as the inlet flow control valve 308. In some such embodiments, the inlet flow control valve 308 may be embodied, for example, as a solenoid-operated valve having its solenoid electrically coupled to the controller C. In some such embodiments, the inlet flow control valve 308 may be configured so that: (a) the inlet port 308A is aligned with the outlet port 308B when the solenoid is de-energized; and (b) the inlet port 308A is isolated from the outlet port 308B when the solenoid is energized.

In some embodiments, the inlet flow controller 308 could be embodied as a calibrated inlet flow check valve 308′ having a first port 308A′ fluidly coupled to the environment E and a second port 308B′ fluidly coupled to the fluid conduit 318 coupled to the pump inlet port and other components of the control system 300, for example, as shown in FIG. 7A. The calibrated inlet flow check valve 308′ is configured to allow flow from the first port 308A′ thereof to the second port 308B′ thereof, and to check flow from the second port 308B′ thereof to the first port 308A′ thereof. As such, the calibrated inlet flow check valve 308′ is configured to allow flow from the environment to the pump inlet port 302A, and to check flow from within the control system 300 to the environment E. In such embodiments, the calibrated inlet flow check valve 308′ is configured to open at a pressure differential selected so that the pump 302 may evacuate the envelope 200 prior to drawing air from the environment E, as will become better understood from the discussion below.

Embodiments including the calibrated inlet flow check valve 308′ as described above lack means for automatically deflating inflated ones of the first and or second inflatable compartments 108, 110, for example, when the control system 300 is powered off, as discussed further below. Instead, such embodiments may require disconnecting the control system 300 from the support surface overlay 10, for example, by breaking the connection at the connector 400, in order to deflate inflated ones of the first and or second inflatable compartments 108, 110. This may be undesirable in some applications.

Accordingly, in some embodiments including the calibrated inlet flow check valve 308′, a flow restrictor 309′, for example, an appropriately sized orifice, may be installed in parallel with the calibrated inlet flow check valve 308′, for example, as shown in FIG. 7B. The flow restrictor 309′ may allow controlled venting or deflation of inflated ones of the first and/or second compartments 108, 110 to the environment when the control system 300 is powered off or otherwise may be desired, as will be discussed further below. At the same time, the flow restrictor 309′ may provide sufficient inhibition to flow of intake air from the environment E during normal operation of the pump 302 to allow the control system 300 to evacuate the first and second compartments 108, 110 and the envelope 200 during normal operation of the control system 300, as will be discussed further below.

In some embodiments, the filter 316 could function as the inlet flow controller, for example, as shown in FIG. 7C, and as will be discussed further below. In such embodiments, the inlet flow control valve 308 and calibrated inlet flow check valve 308′ could be omitted.

The pressure relief valve 310 has an inlet port 310A fluidly to the pump outlet port 302B, and an outlet port 310B fluidly coupled to the environment E. The pressure relief valve 310 may be embodied as any form of pressure relief valve configured to be normally closed and to open when the pressure at the inlet port 310A exceeds the pressure at the outlet port 310B (which may be the ambient pressure of the environment E) by a first predetermined pressure value (or setpoint pressure).

The first pressure sensor 312 is fluidly coupled to the fluid conduit 318 between the second port 304B of the first three-way control valve 304 and the first variable air volume Z1, and electrically coupled to the controller C. The first pressure sensor 312 is configured to detect the pressure within the fluid conduit 318 between the second port 304B of the first three-way control valve 304 and the first variable air volume Z1, and to provide a signal indicative of the pressure within the fluid conduit 318 between the second port 304B of the first three-way control valve 304 and the first variable air volume Z1 to the controller C.

The second pressure sensor 314 is fluidly coupled to the fluid conduit 318 between the second port 306B of the second three-way control valve 306 and the second variable air volume Z2, and electrically coupled to the controller C. The second pressure sensor 314 is configured to detect the pressure within the fluid conduit 318 between the second port 306B of the second three-way control valve 306 and the second variable air volume Z2, and to provide a signal indicative of the pressure within the fluid conduit 318 between the second port 306B of the second three-way control valve 306 and the second variable air volume Z2 to the controller C.

The inlet filter 316 has an inlet port 316A fluidly coupled to the environment E and an outlet port 316B fluidly coupled to the inlet port of the inlet flow controller 308. The inlet filter 316 is configured to filter particulate matter from inlet air entering the control system 300 from the environment E.

As does any filter, the inlet filter 316 exhibits flow restriction characteristics that impart an impediment to air flow therethrough. In some embodiments, as suggested above, the flow restriction characteristics of the inlet filter 316 could be selected to be sufficiently great so as to enable the inlet filter 316 to function as the inlet flow controller 308. In such embodiments, the outlet port 316B of the inlet filter 316 would be fluidly coupled to the pump inlet port 302A.

The controller C is configured to receive control inputs from a user-operable control interface (not shown) and from the first and second pressure sensors 312, 314. The controller C also is configured to provide control outputs to the solenoids of the first and second three-way control valves 304, 306 and the inlet flow control valve 308. The controller C may be further configured to provide output signals to one or more of a display, indicator lamps or other visual indicators and speakers, chimes, or other audio indicators (not shown) that may provide a user with the status of operation of the control system 300. For example, the controller C may provide to the indicator lamps, audio elements, or display other status outputs reflecting whether the control system 300 is initializing, performing start-up testing, inflating a particular one of the first and second inflatable compartments 108, 110, deflating a particular one of the first and second inflatable compartments 108, 110, evacuating air from the envelope 200, and so on.

The controller C is configured to control the operation of the pump 302, the first and second three-way control valves 304, 306, and the inlet control valve 308 in response to user input to the control interface (not shown) and in response to pressure signals received from the first and second pressure sensors 312, 314, according to predetermined criteria and or logic that may be programmed into the controller C in hardware, software, or both, as will be discussed further below.

Various illustrative operational states of the support surface overlay 10 and control system 300 will now be discussed in detail.

### First Operational State—Stand-By, Powered Off

FIG. 7 shows schematically the support surface overlay 10 coupled to the pneumatic control system 300 in a first operational state according to the present disclosure. In the first operational state, the control unit 300 is in a stand-by, powered off state. As such, the pump 302, the solenoids of the first and second three-way control valves 304, 306 and the inlet flow control valve 308, and the first and second pressure sensors 312, 314 are de-energized. Also, the support surface overlay 10 is generally deflated.

More specifically, in the first operational state: (a) the first port 304A of the first three-way control valve 304 is aligned with the second port 304B of the first three-way control valve 304, and the third port 304C of the first three-way control valve 304 is isolated from the first port 304A and the second port 304B of the first three-way control valve 304; (b) the first port 306A of the second three-way control valve 306 is aligned with the second port 306B of the second three-way control valve 306, and the third port 306C of the second three-way control valve 306 is isolated from the first port 306A and the second port 306B of the second three-way control valve 306; and (c) the inlet port 308A of the inlet flow control valve 308 is aligned with the outlet port 308B of the inlet flow control valve.

As such, the pump inlet port 302A is aligned with the first and second variable air volumes Z1, Z2 via the first and second three-way control valves 304, 306, with the environment E via the inlet flow control valve 308, and with the third variable air volume Z3 via the check valve 214 of the support surface overlay system 10. The first and second variable air volumes Z1, Z2 are aligned with each other via the first and second three-way control valves 304, 306. The pump outlet 302B is isolated from the first and second variable air volumes Z1, Z2 by the first and second three-way control valves 304, 306. Also, the first, second, and third air variable volumes Z1, Z2, Z3 may be at ambient pressure (that is, the pressure of the environment E) and in a mostly empty or deflated state.

The pressure in the fluid conduit 318 coupling the pump outlet port 302B with the third ports 304C, 306C of the first and second three-way control valves 304, 306 and the inlet port 310A of the pressure relief valve 310 may be at or near ambient pressure and, in any event, is lower than the pressure relief valve 310 setpoint pressure. As such, the pressure relief valve 310 is closed.

### Second Operational State—Start-Up/Diagnostic Check

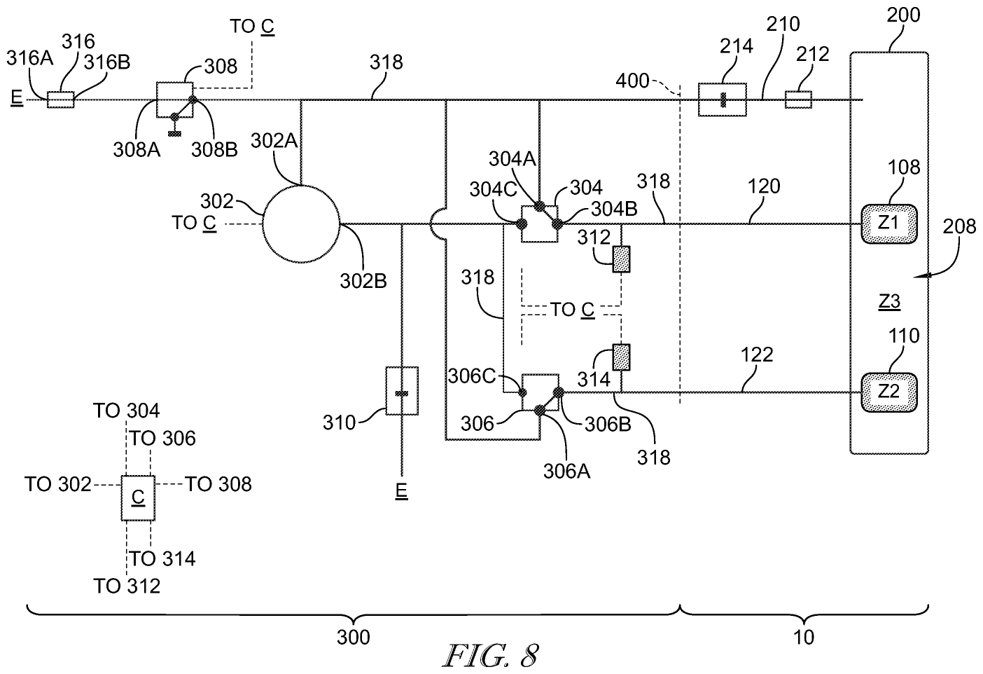

FIG. 8 shows schematically the support surface overlay 10 coupled to the pneumatic control system 300 in a second operational state according to the present disclosure. In the second operational state, the control unit 300 is configured to draw a vacuum on the first, second, and third variable air volumes Z1, Z2, Z3 and to check for leaks in the first, second, and third variable air volumes Z1, Z2, Z3 or in the fluid conduits 318 or connector 400 connecting them to the control system 300.

More specifically, in the second operational state: (a) the first port 304A of the first three-way control valve 304 is aligned with the second port 304B of the first three-way control valve 304, and the third port 304C of the first three-way control valve 304 is isolated from the first port 304A and the second port 304B of the first three-way control valve 304; (b) the first port 306A of the second three-way control valve 306 is aligned with the second port 306B of the second three-way control valve 306, and the third port 306C of the second three-way control valve 306 is isolated from the first port 306A and the second port 306B of the second three-way control valve 306; and (c) the inlet port 308A of the inlet flow control valve 308 is isolated from the outlet port 308B of the inlet flow control valve.

As such, the pump inlet port 302A is aligned with the first and second variable air volumes Z1, Z2 via the first and second three-way control valves 304, 306, and with the third variable air volume Z3 via the check valve 214 of the support surface overlay system 10. The pump inlet port 302A is isolated from the environment E by the inlet flow control valve 308, The first and second variable air volumes Z1, Z2 are aligned with each other via the first and second three-way control valves 304, 306. Further, the pump outlet 302B is isolated from the first and second variable air volumes Z1, Z2 by the first and second three-way control valves 304, 306.

The pump 302 is running and thereby withdraws air from the first, second and third variable air volumes Z1, Z2, Z3. The check valve 214 may selectively open as may be necessary to allow air to be withdrawn from the third variable air volume Z3. Otherwise, the check valve 214 is closed. The pump 302 pressurizes the air withdrawn from the first, second and third variable air volumes Z1, Z2, Z3 and discharges it through the pump outlet port 302B into the fluid conduit coupling the pump outlet port 302B with the third ports 304C, 306C of the first and second three-way control valves 304, 306 and with the inlet port 310A of the pressure relief valve 310. Because the third ports 304C, 306C of the first and second three-way control valves 304, 306 are isolated, the pressure relief valve 310 may open if the pressure in the foregoing fluid conduit 318 exceeds the pressure relief valve 310 setpoint pressure.

The first pressure sensor 312 is detecting pressure within the fluid conduit 318 coupling the second port 304B of the first three-way control valve 304 to the first variable air volume Z1. The second pressure sensor 314 is detecting pressure within the fluid conduit 318 coupling the second port 306B of the second three-way control valve 306 to the second variable air volume Z2.

The pump 302 continues to operate and thereby draw a vacuum on the first and second variable air volumes Z1, Z2 until each of the first and second pressure sensors 312, 314 detects a pressure in the respective fluid conduit 318 less than a second predetermined pressure value indicative of a vacuum in the respective fluid conduit 318. The second predetermined pressure value may be, for example, −0.5 psig or another pressure value less than zero psig. The pump 302 may then turn off for a predetermined time period, for example, 10 seconds. If the pressure detected by the first and second pressure sensors 312, 314 holds for the predetermined time period, the controller C may provide an output indicating a successful vacuum check. If not, the controller C may provide an output indicating a failed vacuum check. A failed vacuum check may be the result of a leaking connection, for example, at the connector 400 connecting the control system 300 to the first, second, and third variable air volumes Z1, Z2, Z3.

As suggested above, the controller C may provide outputs indicating successful or failed vacuum checks to one or more of corresponding indicator lamps, audio elements, or a display (not shown) configured to provide visual and/or audio indication of the vacuum check success or failure.

### Third Operational State—Initial Pressurization of First Inflatable Compartment

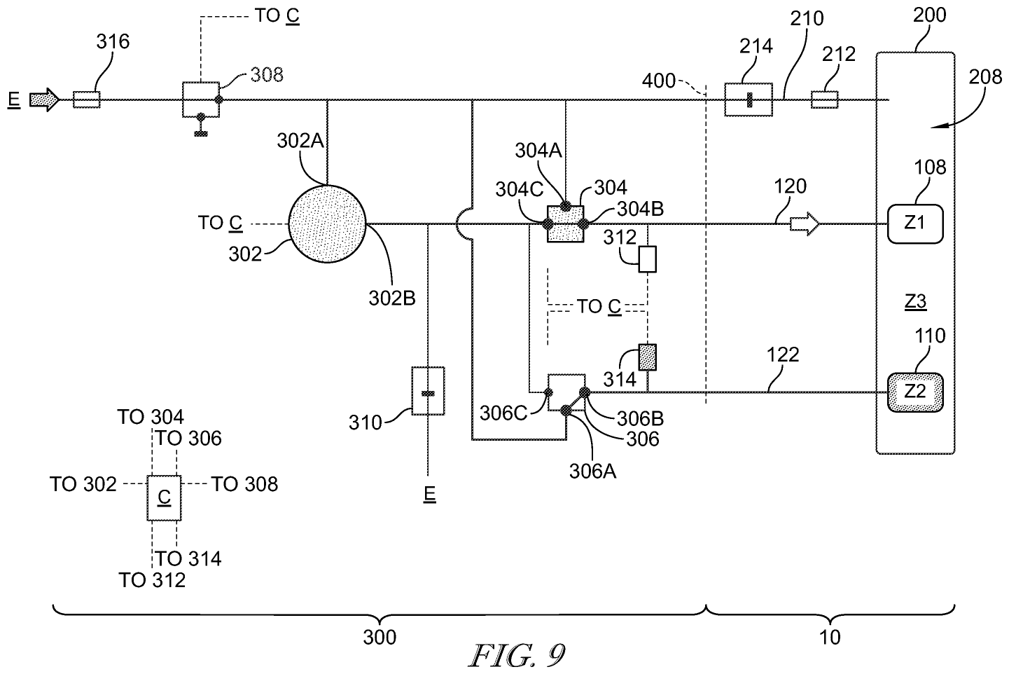

FIG. 9 shows schematically the support surface overlay 10 coupled to the pneumatic control system 300 in a third operational state according to the present disclosure. In the third operational state, the control unit 300 is configured to enable to pump 302 to draw intake air from the environment E and to discharge pressurized air to the first variable air volume Z1, thereby inflating the first inflatable compartment 108.

More specifically, in the third operational state: (a) the second port 304B of the first three-way control valve 304 is aligned with the third port 304C of the first three-way control valve 304, and the first port 304A of the first three-way control valve 304 is isolated from the second port 304B and the third port 304C of the first three-way control valve 304; (b) the first port 306A of the second three-way control valve 306 is aligned with the second port 306B of the second three-way control valve 306, and the third port 306C of the second three-way control valve 306 is isolated from the first port 306A and the second port 306B of the second three-way control valve 306; and (c) the inlet port 308A of the inlet flow control valve 308 is aligned with the outlet port 308B of the inlet flow control valve.

As such, the pump inlet port 302A is aligned with the second variable air volume Z2 via the second three-way control valve 306, with the third variable air volume Z3 via the check valve 214, and with the environment E via the inlet flow control valve 302. The pump inlet port 302A is isolated from the first variable air volume Z1 by the first three-way control valve 304. The pump outlet port 302B is aligned with the first variable air volume Z1 via the first three-way control valve 304, and isolated from the second variable air volume Z2 by the second three-way control valve 306.

The pump 302 is running and thereby withdraws intake air from the environment E. The pump 302 also may draw intake air, if any, from the second and third variable air volumes Z2, Z3. The check valve 214 may selectively open as may be necessary to allow air to be withdrawn from the third variable air volume Z3. Otherwise, the check valve 214 is closed. The pump 302 pressurizes the intake air and discharges it through the pump outlet port 302B to the first variable air volume Z1 via the first three-way control valve 304.

The first pressure sensor 312 detects increasing pressure in the fluid conduit 318 coupling the first three-way control valve 304 with the first variable air volume Z1.

### Fourth Operational State—Further Pressurization of First Inflatable Compartment and Evacuation of Second Inflatable Compartment and Envelope

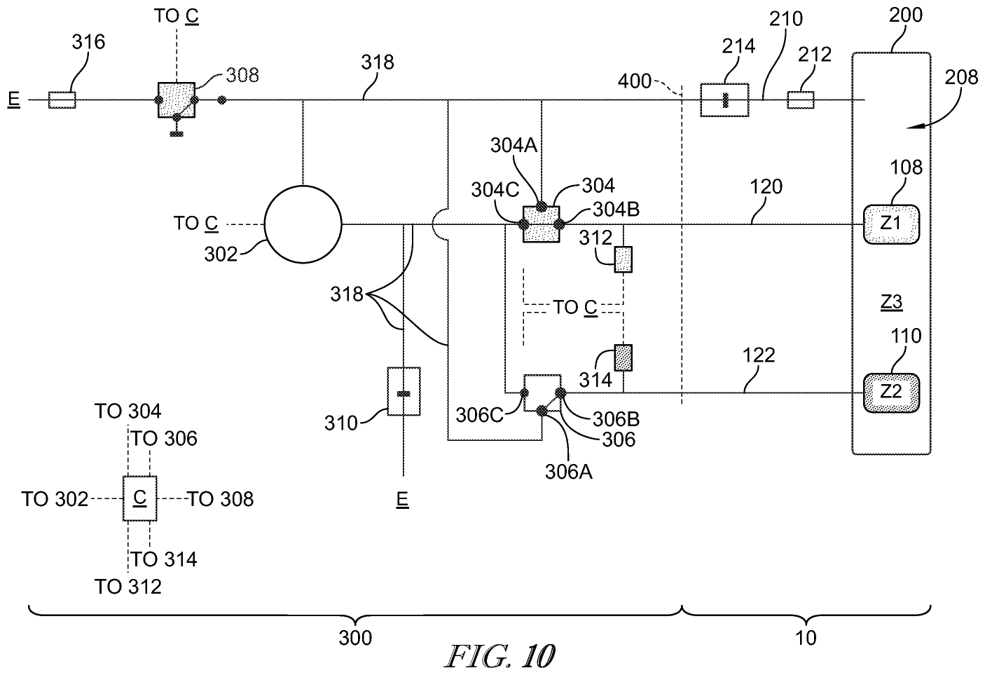

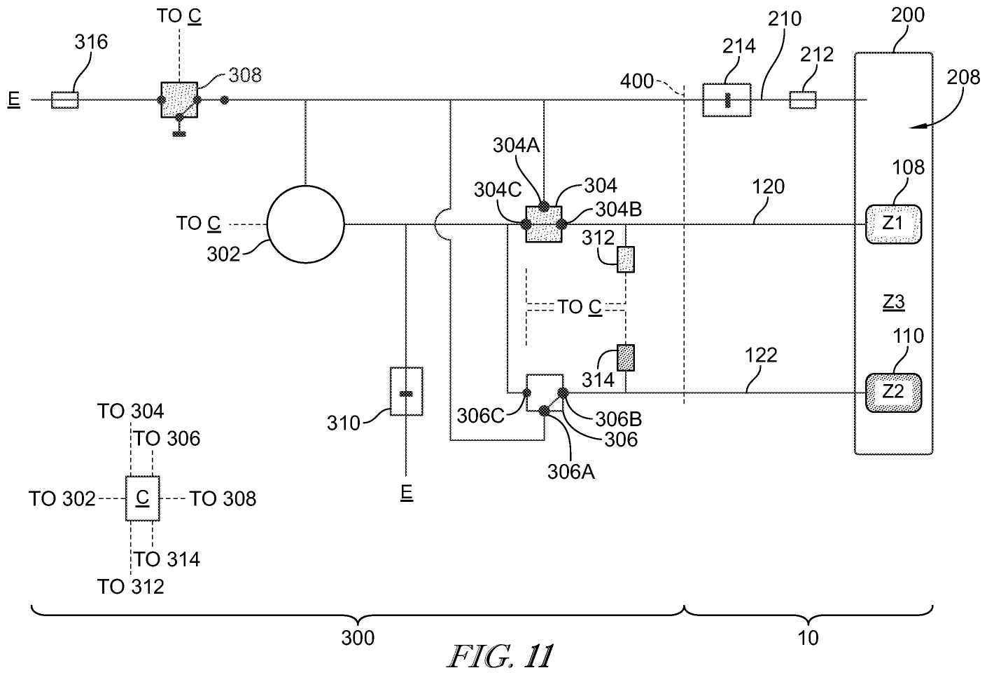

FIG. 10 shows schematically the support surface overlay 10 coupled to the pneumatic control system 300 in a fourth operational state according to the present disclosure. In the fourth operational state, the control unit 300 is configured to isolate the pump inlet port 302A from the environment E, to enable the pump 302 to withdraw air from the second and third variable air volumes Z2, Z3, and to discharge pressurized air to the first variable air volume Z1, thereby continuing to inflate the first inflatable compartment 108 and to evacuate the second inflatable compartment 110 and the envelope 200.

More specifically, in the fourth operational state: (a) the second port 304B of the first three-way control valve 304 is aligned with the third port 304C of the first three-way control valve 304, and the first port 304A of the first three-way control valve 304 is isolated from the second port 304B and the third port 304C of the first three-way control valve 304; (b) the first port 306A of the second three-way control valve 306 is aligned with the second port 306B of the second three-way control valve 306, and the third port 306C of the second three-way control valve 306 is isolated from the first port 306A and the second port 306B of the second three-way control valve 306; and (c) the inlet port 308A of the inlet flow control valve 308 is isolated from the outlet port 308B of the inlet flow control valve.

As such, the pump inlet port 302A is aligned with the second variable air volume Z2 via the second three-way control valve 306, and with the third variable air volume Z3 via the check valve 214. The pump inlet port 302A is isolated from the environment E by the inlet flow control valve 308, and from the first variable air volume Z1 by the first three-way control valve 304. The pump outlet port 302B is aligned with the first variable air volume Z1 via the first three-way control valve 304, and isolated from the second variable air volume Z2 by the second three-way control valve 306.

The pump 302 is running and thereby withdraws air, if any, from the second and third variable air volumes Z2, Z3, thereby evacuating the second and third variable air volumes Z2, Z3, and collapsing the first and second sheets 202, 204 of the envelope 200 against the first and second sheets 102, 104 of the bladder 100. The check valve 214 may selectively open as may be necessary to allow air to be withdrawn from the third variable air volume Z3. Otherwise, the check valve 214 is closed. The pump 302 pressurizes the intake air and discharges it through the pump outlet port 302B to the first variable air volume Z1 via the first three-way control valve 304, thereby continuing to inflate and pressurize the first inflatable compartment 108.

The first pressure sensor 312 detects increasing pressure in the fluid conduit 318 coupling the first three-way control valve 304 with the first variable air volume Z1. The second pressure sensor 314 detects decreasing pressure (or increasing vacuum) in the fluid conduit 318 coupling the second three-way control valve 306 with the second variable air volume Z2.

### Fifth Operational State—Steady State, First Inflatable Compartment Inflated

FIG. 11 shows schematically the support surface overlay 10 coupled to the pneumatic control system 300 in a fifth operational state according to the present disclosure. In the fifth operational state, the control unit 300 is configured to maintain the first inflatable compartment 108 in a fully inflated state.

In the fifth operational state, the control system 300 is configured in the same manner as in the fourth operational state, except that in the pump 302 is not running in the fifth operational state. The pump 302 changes from the running condition of the fourth operational state to the off condition of the fifth operational state when the first pressure sensor 312 detects pressure in the fluid conduit 318 coupling the first three-way control valve 304 to the first variable air volume Z1 in excess of a third predetermined pressure corresponding to the desired inflation pressure of the first inflatable compartment. The third predetermined pressure may be any desired pressure value, for example, any pressure value between 0.5 psig and 10 psig.

While in the fifth operational state, the first pressure sensor 312 continues to detect pressure in the fluid conduit 318 coupling the first three-way control valve 304 to the first variable air volume Z1, and the second pressure sensor 314 continues to detect pressure in the fluid conduit 318 coupling the second three-way control valve 306 to the second variable air volume Z2.

The control system 300 may be maintained in the fifth operational state for a predetermined time, which may be any desired period of time. For example, the predetermined time may be any interval between two minutes and four minutes or a shorter or longer interval.

### Sixth Operational State—Steady State, Leakage Compensation

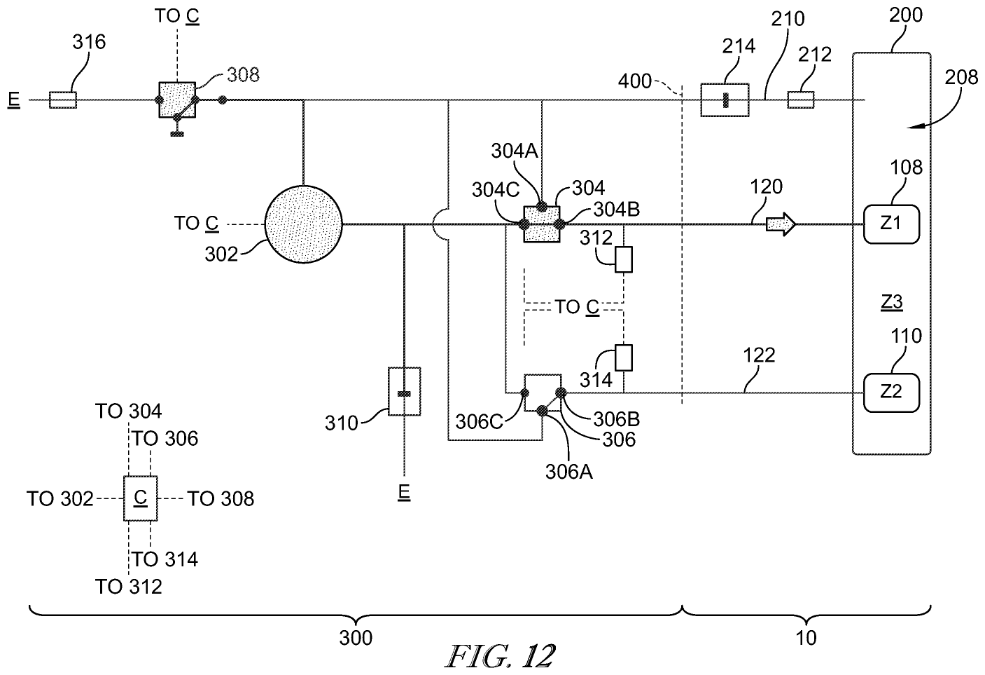

FIG. 12 shows schematically the support surface overlay 10 coupled to the pneumatic control system 300 in a sixth operational state according to the present disclosure. In the sixth operational state, the control unit 300 is configured to compensate for possible, unintended, leakage from the pressurized first inflatable compartment 108 into the evacuated second inflatable compartment 110 or into the evacuated envelope 200 by cycling the pump 302 on and off as may be necessary in an effort to maintain the pressure in the first inflatable compartment 108 as determined by the first pressure sensor 312 at the desired pressure, and to maintain the second inflatable compartment 110 and the envelope 200 in respective evacuated states.

In the sixth operational state, the control system 300 is configured in the same manner as in the fifth operational state, except that the pump 302 cycles on and off as may be necessary to maintain the pressure in the first inflatable compartment 108 at the desired pressure.

### Seventh Operational State—Initial Deflation of First Inflatable Compartment and Inflation of Second Inflatable Compartment; Pressure Equalization

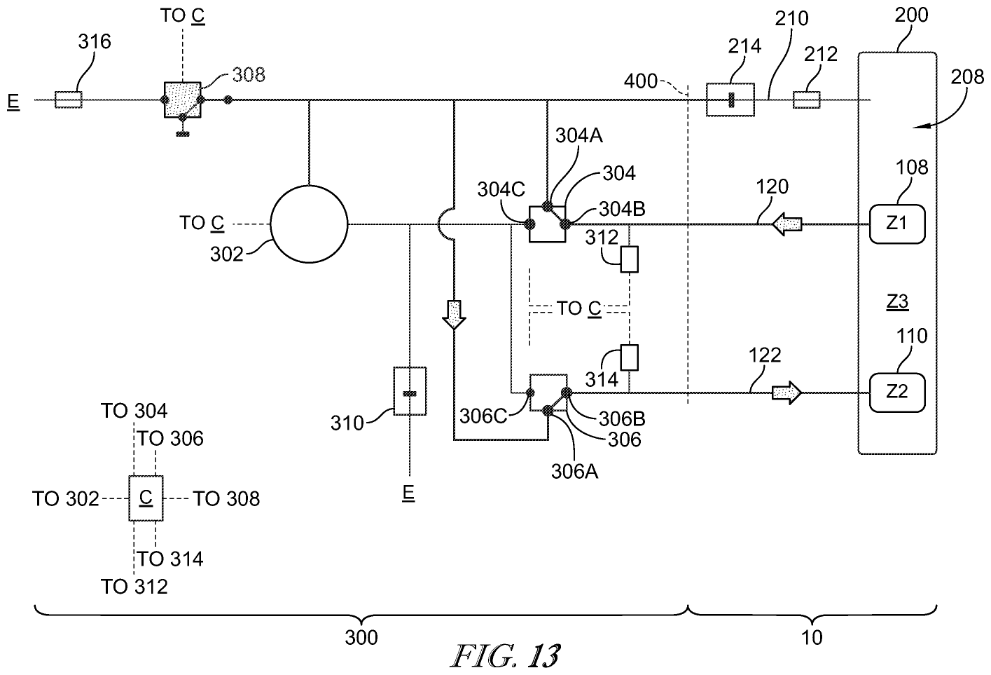

FIG. 13 shows schematically the support surface overlay 10 coupled to the pneumatic control system 300 in a seventh operational state according to the present disclosure. In the seventh operational state, the control unit 300 is configured to fluidly couple the first inflatable compartment 108 with the second inflatable compartment 110, and to isolate the first and second inflatable compartments 108, 110 from the environment E. In some embodiments, the seventh operational state immediately follows the sixth operational state. As such, in the seventh operational state, pressurized air from the first inflatable compartment 108 may flow to the evacuated second inflatable compartment 110 until the pressure in the first and second inflatable compartments 108, 110 has equalized.

More specifically, in the seventh operational state: (a) the first port 304A of the first three-way control valve 304 is aligned with the second port 304B of the first three-way control valve 304, and the third port 304C of the first three-way control valve 304 is isolated from the first port 304A and the second port 304B of the first three-way control valve 304; (b) the first port 306A of the second three-way control valve 306 is aligned with the second port 306B of the second three-way control valve 306, and the third port 306C of the second three-way control valve 306 is isolated from the first port 306A and the second port 306B of the second three-way control valve 306; and (c) the inlet port 308A of the inlet flow control valve 308 is isolated from the outlet port 308B of the inlet flow control valve.

Also, in the seventh operational state, the pump 302 is off. The first pressure sensor 312 detects decreasing pressure in the fluid conduit 318 coupling the first three-way control valve 304 with the first variable air volume Z1, and the second pressure sensor 314 detects increasing pressure in the fluid conduit 318 coupling the second three-way control valve 306 with the second variable air volume Z2.

### Eighth Operational State—Further Deflation of First Inflatable Compartment and Inflation of Second Inflatable Compartment

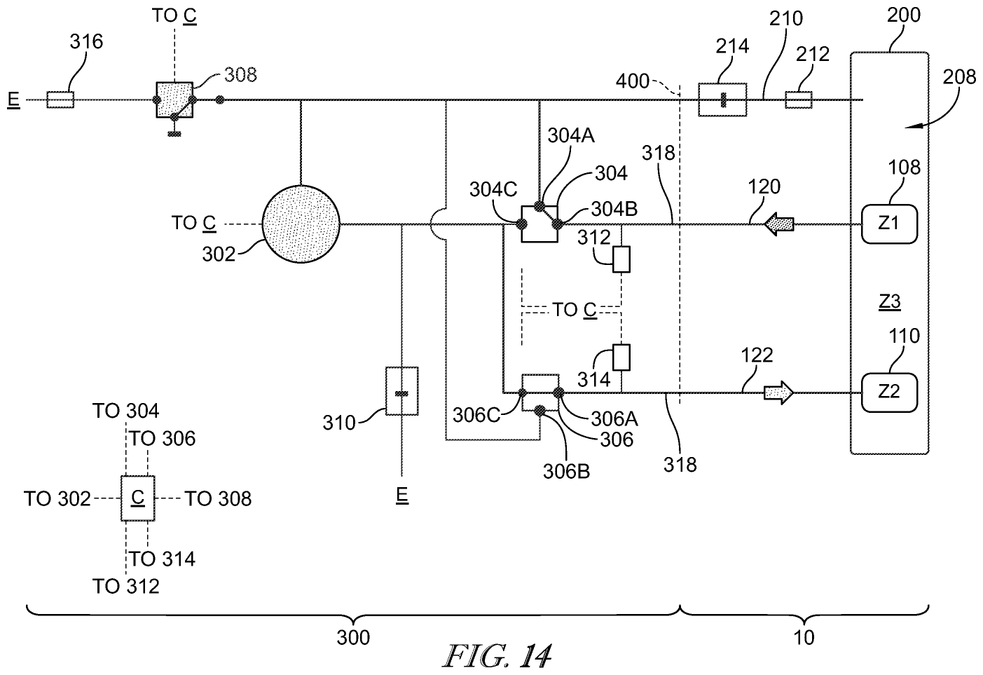

FIG. 14 shows schematically the support surface overlay 10 coupled to the pneumatic control system 300 in an eighth operational state according to the present disclosure. In the eighth operational state, the control unit 300 is configured to enable the pump 302 to withdraw air from the first variable air volume Z1, to pressurize the air withdrawn from the first variable air volume Z1, and to discharge the pressurized air to the second variable air volume Z2.

More specifically, in the eighth operational state: (a) the first port 304A of the first three-way control valve 304 is aligned with the second port 304B of the first three-way control valve 304, and the third port 304C of the first three-way control valve 304 is isolated from the first port 304A and the second port 304B of the first three-way control valve 304; (b) the second port 306B of the second three-way control valve 306 is aligned with the third port 306C of the second three-way control valve 306, and the first port 306A of the second three-way control valve 306 is isolated from the second port 306B and the third port 306C of the second three-way control valve 306; and (c) the inlet port 308A of the inlet flow control valve 308 is isolated from the outlet port 308B of the inlet flow control valve.

As such, the pump inlet port 302A is aligned with the first variable air volume Z1 via the first three-way control valve 304, and with the third variable air volume Z3 via the check valve 214. The pump inlet port 302A is isolated from the environment E by the inlet flow control valve 308, and from the second variable air volume Z2 by the second three-way control valve 306. The pump outlet port 302B is aligned with the second variable air volume Z2 via the second three-way control valve 306, and isolated from the first variable air volume Z1 by the first three-way control valve 304.

The pump 302 is running and thereby withdraws air, if any, from the first and third variable air volumes Z1, Z3, thereby evacuating the first and third variable air volumes Z1, Z3, and collapsing the first and second sheets 202, 204 of the envelope 200 against the first and second sheets 102, 104 of the bladder 100. The check valve 214 may selectively open as may be necessary to allow air to be withdrawn from the third variable air volume Z3. Otherwise, the check valve 214 is closed. The pump 302 pressurizes the intake air and discharges it through the pump outlet port 302B to the second variable air volume Z2 via the second three-way control valve 306, thereby continuing to inflate and pressurize the second inflatable compartment 110.

The first pressure sensor 312 detects decreasing pressure (or increasing vacuum) in the fluid conduit 318 coupling the first three-way control valve 304 with the first variable air volume Z1. The second pressure sensor 314 detects further increasing pressure in the fluid conduit 318 coupling the second three-way control valve 306 with the second variable air volume Z2.

### Ninth Operational State—Admission of Makeup Air

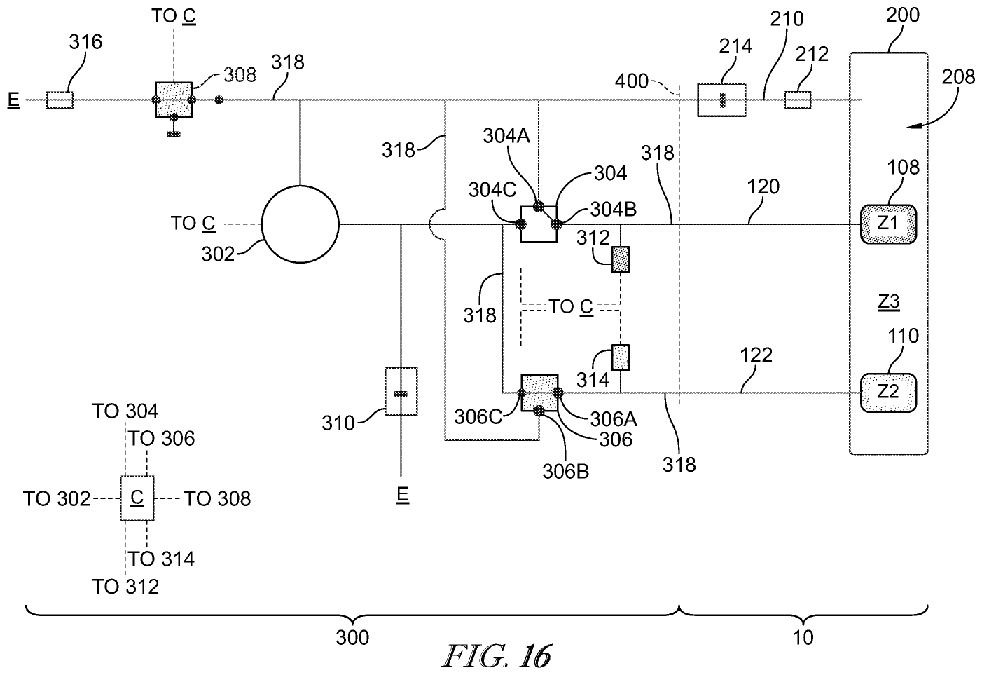

FIG. 16 shows schematically the support surface overlay 10 coupled to the pneumatic control system 300 in a ninth operational state according to the present disclosure. The ninth operational state is similar to the eighth operational state, except that the control system 300 is configured to briefly enable the pump 302 to further withdraw makeup air from the environment E, to pressurize the further air withdrawn from the environment E, and to discharge the pressurized air to the second variable air volume Z2.

More specifically, in the ninth operational state: (a) the first port 304A of the first three-way control valve 304 is aligned with the second port 304B of the first three-way control valve 304, and the third port 304C of the first three-way control valve 304 is isolated from the first port 304A and the second port 304B of the first three-way control valve 304; (b) the second port 306B of the second three-way control valve 306 is aligned with the third port 306C of the second three-way control valve 306, and the first port 306A of the second three-way control valve 306 is isolated from the second port 306B and the third port 306C of the second three-way control valve 306; (b); and (c) the inlet port 308A of the inlet flow control valve 308 is aligned with the outlet port 308B of the inlet flow control valve.

As such, the pump inlet port 302A is briefly aligned with the environment E via the inlet flow control valve 308. Also, the pump inlet port 302A remains aligned with the first variable air volume Z1 via the first three-way control valve 304, and with the third variable air volume Z3 via the check valve 214. The pump inlet port 302A is isolated from the second variable air volume Z2 by the second three-way control valve 306. The pump outlet port 302B is aligned with the second variable air volume Z2 via the second three-way control valve 306, and isolated from the first variable air volume Z1 by the first three-way control valve 304.

The pump 302 is running and thereby further withdraws intake air from the environment E. The pump 302 pressurizes the intake air and discharges it through the pump outlet port 302B to the second variable air volume Z2 via the second three-way control valve 306, thereby continuing to inflate and pressurize the second inflatable compartment 110.

The first pressure sensor 312 may detect further decreasing pressure (or increasing vacuum) in the fluid conduit 318 coupling the first three-way control valve 304 with the first variable air volume Z1. The second pressure sensor 314 detects further increasing pressure in the fluid conduit 318 coupling the second three-way control valve 306 with the second variable air volume Z2.

### Tenth Operational State—Steady State, Second Inflatable Compartment Inflated

FIG. 16 shows schematically the support surface overlay 10 coupled to the pneumatic control system 300 in a tenth operational state according to the present disclosure. In the tenth operational state, the control unit 300 is configured to maintain the second inflatable compartment 110 in a fully inflated state.

In the tenth operational state, the control system 300 is configured in the same manner as in the ninth operational state, except that the inlet flow control valve 308 is closed and the pump 302 is not running. The pump 302 changes from the running condition of the ninth operational state to the off condition of the tenth operational state after the inlet flow control valve 308 has closed and when the second pressure sensor 314 detects pressure in the fluid conduit 318 coupling the second three-way control valve 306 to the second variable air volume Z2 in excess of a fourth predetermined pressure corresponding to the desired inflation pressure of the second inflatable compartment 110. The fourth predetermined pressure may be any desired pressure value, for example, any pressure value between 0.5 psig and 10 psig. The fourth predetermined pressure may be, but need not be, the same as the third predetermined pressure.

While in the tenth operational state, the first pressure sensor 312 continues to detect pressure in the fluid conduit 318 coupling the first three-way control valve 304 to the first variable air volume Z1, and the second pressure sensor 314 continues to detect pressure in the fluid conduit 318 coupling the second three-way control valve 306 to the second variable air volume Z2.

The control system 300 may be maintained in the tenth operational state for a predetermined time, which may be any desired period of time. For example, the predetermined time may be any interval between two minutes and four minutes or a shorter or longer interval.

### Eleventh Operational State—Steady State, Leakage Compensation

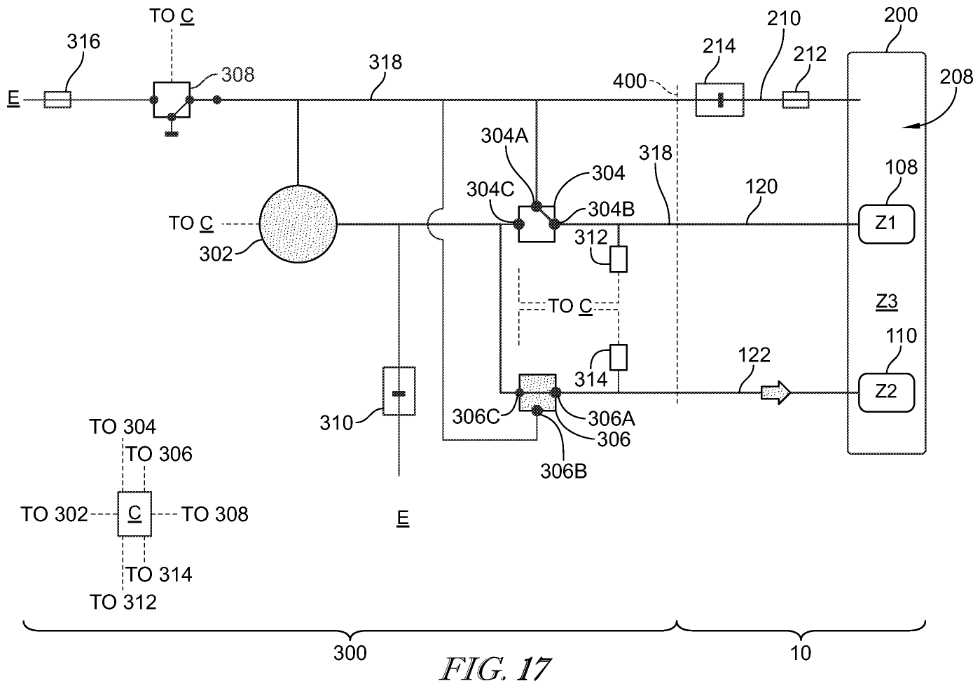

FIG. 17 shows schematically the support surface overlay 10 coupled to the pneumatic control system 300 in an eleventh operational state according to the present disclosure. In the eleventh operational state, the control system 300 is configured to compensate for possible, unintended, leakage from the pressurized second inflatable compartment 110 into the evacuated first inflatable compartment 108 or into the evacuated envelope 200 by cycling the pump 302 on and off as may be necessary in an effort to maintain the pressure in the second inflatable compartment 110 at the desired pressure, and to maintain the first inflatable compartment 108 and the envelope 200 in respective evacuated states.

In the eleventh operational state, the control system 300 is configured in the same manner as in the tenth operational state, except that the pump 302 cycles on and off as may be necessary to maintain the pressure in the second inflatable compartment 110 at the desired pressure.

### Twelfth Operational State—Initial Deflation of Second Inflatable Compartment and Inflation of First Inflatable Compartment; Pressure Equalization

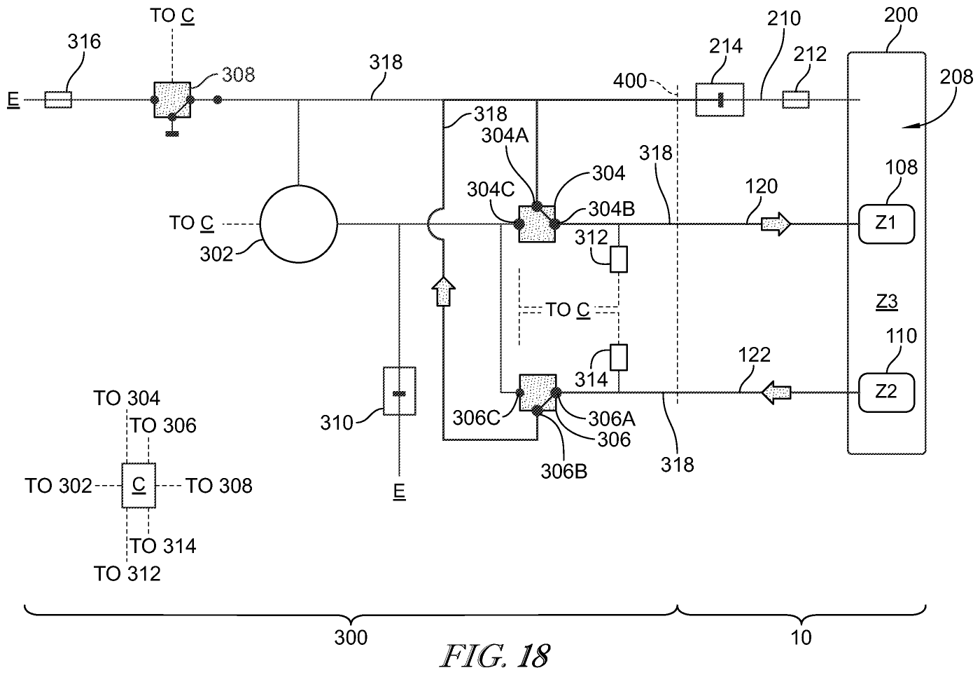

FIG. 18 shows schematically the support surface overlay 10 coupled to the pneumatic control system 300 in an twelfth operational state according to the present disclosure. In the twelfth operational state, the control unit 300 is configured to fluidly couple the first inflatable compartment 108 with the second inflatable compartment 110, and to isolate the first and second inflatable compartments 108, 110 from the environment E. In some embodiments, the twelfth operational state immediately follows the eleventh operational state. As such, in the twelfth operational state, pressurized air from the second inflatable compartment 110 may flow to the evacuated first inflatable compartment 108 until the pressure in the first and second inflatable compartments 108, 110 has equalized.

More specifically, in the twelfth operational state: (a) the first port 304A of the first three-way control valve 304 is aligned with the second port 304B of the first three-way control valve 304, and the third port 304C of the first three-way control valve 304 is isolated from the first port 304A and the second port 304B of the first three-way control valve 304; (b) the first port 306A of the second three-way control valve 306 is aligned with the second port 306B of the second three-way control valve 306, and the third port 306C of the second three-way control valve 306 is isolated from the first port 306A and the second port 306B of the second three-way control valve 306; and (c) the inlet port 308A of the inlet flow control valve 308 is isolated from the outlet port 308B of the inlet flow control valve.

Also, in the twelfth operational state, the pump 302 is off. The first pressure sensor 312 detects increasing pressure in the fluid conduit 318 coupling the first three-way control valve 304 with the first variable air volume Z1, and the second pressure sensor 314 detects decreasing pressure in the fluid conduit 318 coupling the second three-way control valve 306 with the second variable air volume Z2.

### Thirteenth Operational State—Further Deflation of Second Inflatable Compartment and Inflation of First Inflatable Compartment

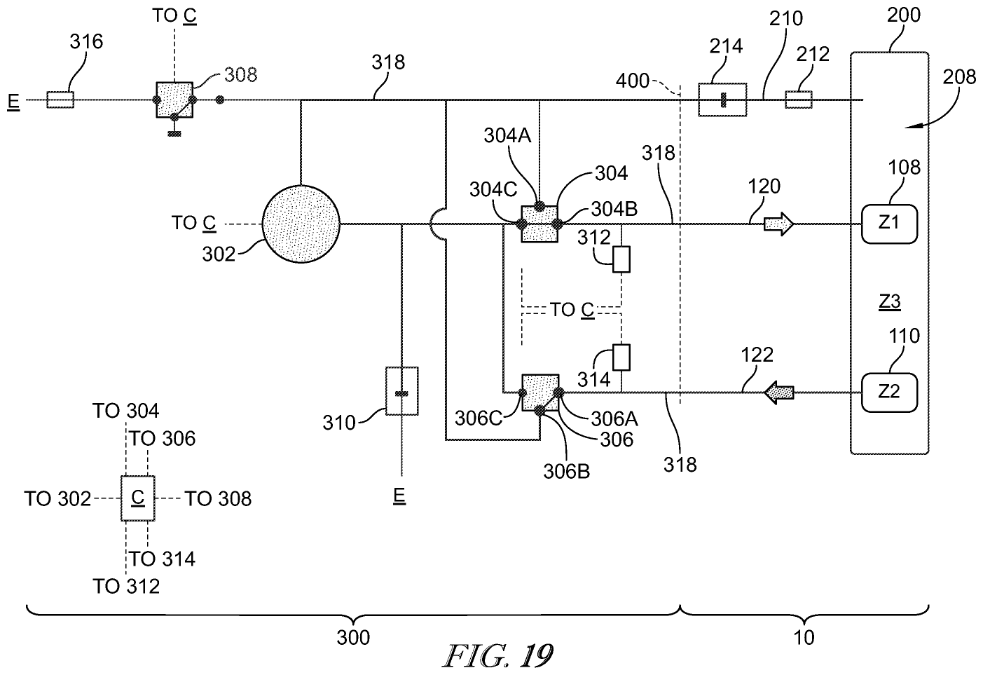

FIG. 19 shows schematically the support surface overlay 10 coupled to the pneumatic control system 300 in a thirteenth operational state according to the present disclosure. In the thirteenth operational state, the control unit 300 is configured to enable the pump 302 to withdraw air from the second variable air volume Z2, to pressurize the air withdrawn from the second variable air volume Z2, and to discharge the pressurized air to the first variable air volume Z1.

More specifically, in the thirteenth operational state: (a) the second port 304B of the first three-way control valve 304 is aligned with the third port 304C of the first three-way control valve 304, and the first port 304A of the first three-way control valve 304 is isolated from the second port 304B and the third port 304C of the first three-way control valve 304; (b) the first port 306A of the second three-way control valve 306 is aligned with the second port 306B of the second three-way control valve 306, and the third port 306C of the second three-way control valve 306 is isolated from the first port 306A and the second port 306B of the second three-way control valve 306; and (c) the inlet port 308A of the inlet flow control valve 308 is isolated from the outlet port 308B of the inlet flow control valve.

As such, the pump inlet port 302A is aligned with the second variable air volume Z2 via the second three-way control valve 306, and with the third variable air volume Z3 via the check valve 214. The pump inlet port 302A is isolated from the environment E by the inlet flow control valve 308, and from the first variable air volume Z1 by the first three-way control valve 304. The pump outlet port 302B is aligned with the first variable air volume Z1 via the first three-way control valve 304, and isolated from the second variable air volume Z2 by the second three-way control valve 306.

The pump 302 is running and thereby withdraws air, if any, from the second and third variable air volumes Z2, Z3, thereby evacuating the second and third variable air volumes Z2, Z3, and collapsing the first and second sheets 202, 204 of the envelope 200 against the first and second sheets 102, 104 of the bladder 100. The check valve 214 may selectively open as may be necessary to allow air to be withdrawn from the third variable air volume Z3. Otherwise, the check valve 214 is closed. The pump 302 pressurizes the intake air and discharges it through the pump outlet port 302B to the first variable air volume Z1 via the first three-way control valve 304, thereby continuing to inflate and pressurize the first inflatable compartment 108.

The first pressure sensor 312 detects increasing pressure in the fluid conduit 318 coupling the first three-way control valve 304 with the first variable air volume Z1. The second pressure sensor 314 detects further decreasing pressure (or increasing vacuum) in the fluid conduit 318 coupling the second three-way control valve 306 with the second variable air volume Z2.

### Fourteenth Operational State—Admission of Makeup Air

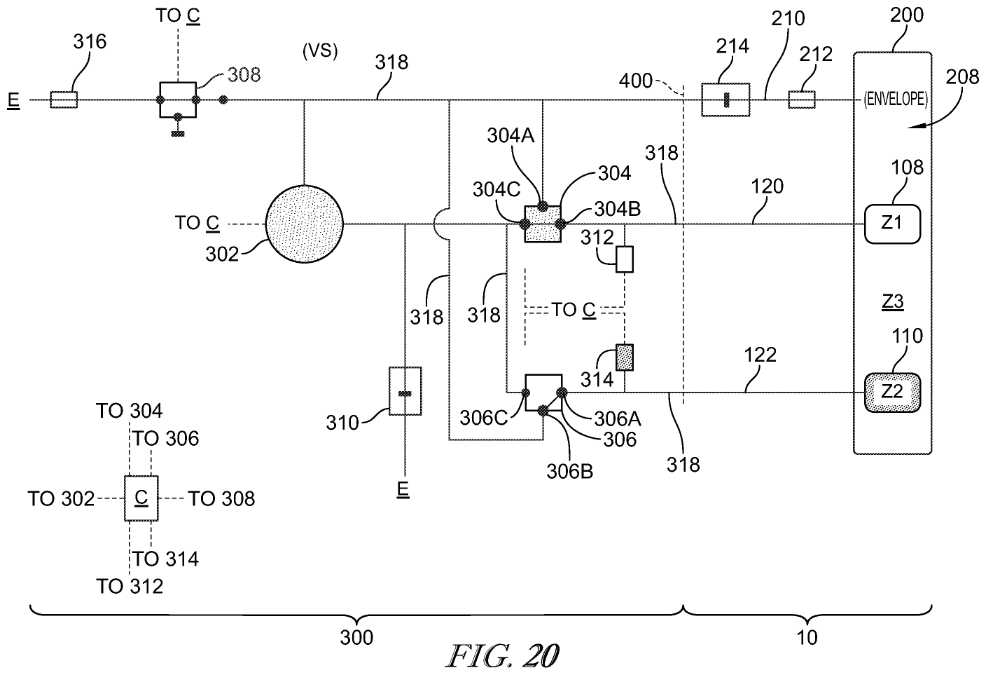

FIG. 20 shows schematically the support surface overlay 10 coupled to the pneumatic control system 300 in a fourteenth operational state according to the present disclosure. The fourteenth operational state is similar to the thriteenth operational state, except that in the fourteenth operational state the control system 300 is configured to briefly enable the pump 302 to further withdraw makeup air from the environment E, to pressurize the further air withdrawn from the environment E, and to discharge the pressurized air to the first variable air volume Z1.

More specifically, in the fourteenth operational state: (a) the second port 304B of the first three-way control valve 304 is aligned with the third port 304C of the first three-way control valve 304, and the first port 304A of the first three-way control valve 304 is isolated from the second port 304B and the third port 304C of the first three-way control valve 304; (b) the first port 306A of the second three-way control valve 306 is aligned with the second port 306B of the second three-way control valve 306, and the third port 306C of the second three-way control valve 306 is isolated from the first port 306A and the second port 306B of the second three-way control valve 306; and (c) the inlet port 308A of the inlet flow control valve 308 is aligned with the outlet port 308B of the inlet flow control valve.

As such, the pump inlet port 302A is briefly aligned with the environment E via the inlet flow control valve 308. Also, the pump inlet port 302A remains aligned with the second variable air volume Z2 via the second three-way control valve 306, and with the third variable air volume Z3 via the check valve 214. The pump inlet port 302A is isolated from the first variable air volume Z1 by the first three-way control valve 304. The pump outlet port 302B is aligned with the first variable air volume Z1 via the first three-way control valve 304, and isolated from the second variable air volume Z2 by the second three-way control valve 306.

The pump 302 is running and thereby further withdraws intake air from the environment E. The pump 302 pressurizes the intake air and discharges it through the pump outlet port 302B to the first variable air volume Z1 via the first three-way control valve 304, thereby continuing to inflate and pressurize the first inflatable compartment 108.

The first pressure sensor 312 detects further increasing pressure in the fluid conduit 318 coupling the first three-way control valve 304 with the first variable air volume Z1. The second pressure sensor 314 may detect further decreasing pressure (or increasing vacuum) in the fluid conduit 318 coupling the second three-way control valve 306 with the second variable air volume Z2.

### Fifteenth Operational State—Steady State, First Inflatable Compartment Inflated

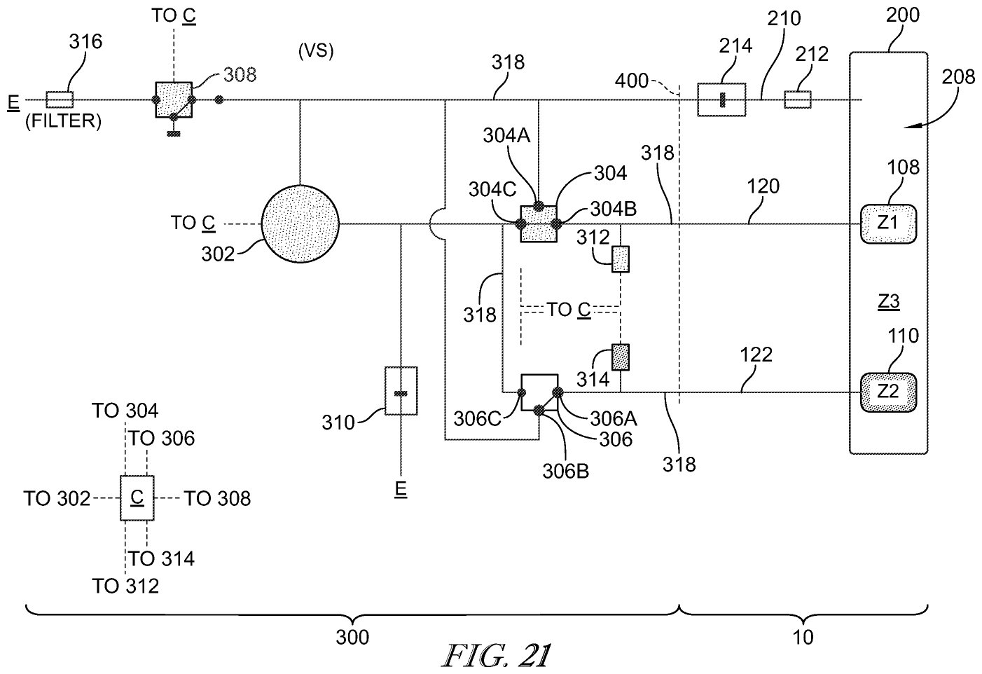

FIG. 21 shows schematically the support surface overlay 10 coupled to the pneumatic control system 300 in a fifteenth operational state according to the present disclosure. In the fifteenth operational state, the control unit 300 is configured to maintain the first inflatable compartment 108 in a fully inflated state.

In the fifteenth operational state, the control system 300 is configured in the same manner as in the fourteenth operational state, except that the inlet flow control valve 308 is closed and the pump 302 is not running. The pump 302 changes from the running condition of the fourteenth operational state to the off condition of the fifteenth operational state after the inlet flow control valve 308 has closed and when the first pressure sensor 312 detects pressure in the fluid conduit 318 coupling the first three-way control valve 304 to the first variable air volume Z1 in excess of the third predetermined pressure corresponding to the desired inflation pressure of the first inflatable compartment 108, as discussed above.

While in the fifteenth operational state, the first pressure sensor 312 continues to detect pressure in the fluid conduit 318 coupling the first three-way control valve 304 to the first variable air volume Z1, and the second pressure sensor 314 continues to detect pressure in the fluid conduit 318 coupling the second three-way control valve 306 to the second variable air volume Z2.

### Sixteenth Operational State—Steady State, First Inflatable Compartment Inflated

As discussed above, FIG. 11 shows schematically the support surface overlay 10 coupled to the pneumatic control system 300 in a fifth operational state according to the present disclosure. FIG. 11 also shows schematically the support surface overlay 10 coupled to the pneumatic control system 300 in a sixteenth operational state according to the present disclosure. In the sixteenth operational state, the control unit 300 is configured to maintain the first inflatable compartment 108 in a fully inflated state in the same manner as shown in, and described above in connection with, FIG. 11.

### Continued Operation of Control System and Support Surface Overlay

The control system 300 may continue to alternatingly inflate and deflate the first and second alternatingly inflatable compartments 108, 110 as described in connection with the sixth through sixteenth operational states as discussed above and shown in the corresponding drawings through as many cycles as desired.

### Shutdown of Control System

The control system 300 and the support surface overlay 10 may be shut down as desired by a user or according to predetermined logic in the controller. The control system 300 may shut down, for example, by powering off. With the control system powered off, the control system 300 and the support surface overlay 10 may revert to the first operational state as described above.

In some embodiments, the fluid connection of the control system 300 to the interior region 208 of the envelope 200 could be omitted. In such embodiments, the fluid conduit 318 coupling the pump inlet port 302A to the third variable air volume would be omitted, and the pump inlet port 302A would be selectively fluidly coupled to the first variable air volume Z1, the second variable air volume Z2, and the environment E, but not to the third variable air volume Z3.

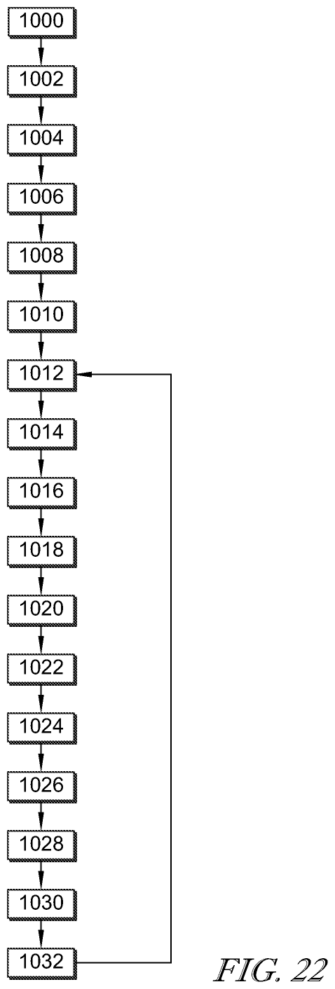

FIG. 22 shows schematically an illustrative method of operating the support surface overlay 10, for example, using the control system 300.

At Step 1000, the support surface overlay 10 and the control system 300 are in an initial, standby-state wherein the support surface overlay is deflated, and the control system 300 is de-energized, for example, as shown in and described in connection with FIG. 7.

At Step 1002, the control system 300 is configured and operating to conduct a vacuum check on the first and second inflatable compartments 108, 110 and the envelope 200, for example, as shown in and described in connection with FIG. 8.

At Step 1004, the control system 300 is configured and operating to begin inflating the first inflatable compartment 108 using air drawn from the environment E, for example, as shown in and described in connection with FIG. 9.

At Step 1006, the control system 300 is configured and operating to complete inflating the first inflatable compartment 108 to a desired, predetermined inflation pressure and to draw a vacuum on the second inflatable compartment 110 and the envelope 200, for example, as shown in and described in connection with FIG. 10.

At Step 1008, the control system 300 is configured and operating to hold the first inflatable compartment 108 at the predetermined inflation pressure, for example, as shown in and described in connection with FIG. 11.

At Step 1010, the control system 300 is configured and operating to mitigate leakage from the first inflatable compartment 108 into the second inflatable compartment 110 or the envelope 200, for example, as shown in and described in connection with FIG. 12.

At Step 1012, the control system 300 is configured and operating to vent pressurized air from the first inflatable compartment 108 to the second inflatable compartment 110 and to equalize air pressure in the first inflatable compartment 108 and the second inflatable compartment 110, thereby partially inflating the second inflatable compartment 110, for example, as shown in and described in connection with FIG. 13.

At Step 1014, the control system 300 is configured and operating to withdraw air from the first inflatable compartment 108 and discharge the air withdrawn from the first inflatable compartment 108 under pressure to the second inflatable compartment 110 to thereby more fully inflate the second inflatable compartment 110, for example, as shown in and described in connection with FIG. 14.

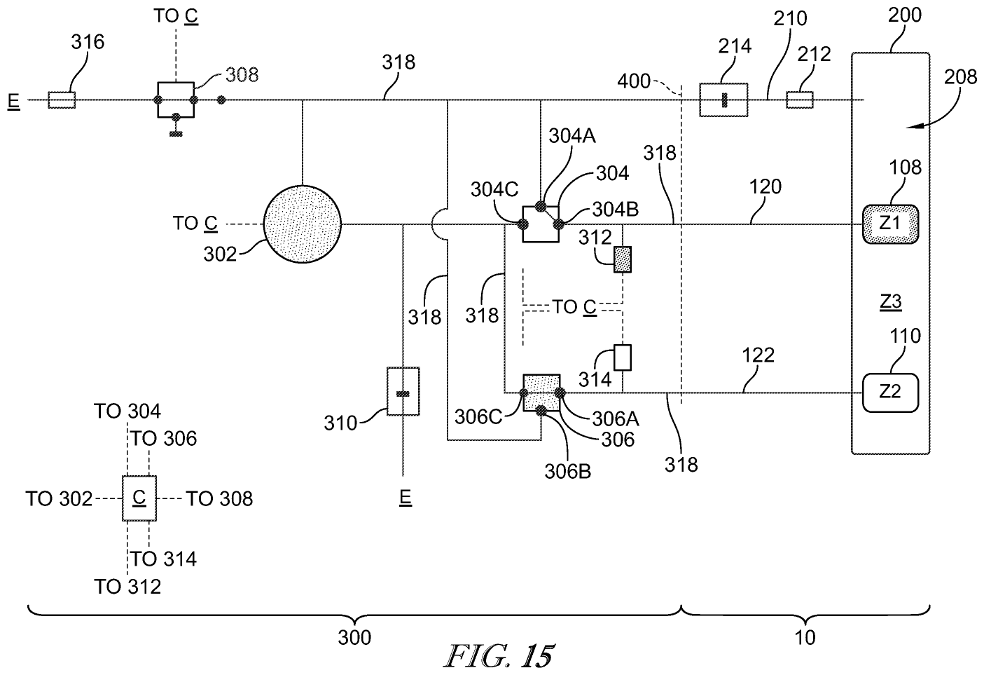

At Step 1016, the control system 300 is configured and operating to briefly withdraw makeup air from the environment E and discharge the air withdrawn from the environment E under pressure to the second inflatable compartment 110 to thereby more fully inflate the second inflatable compartment 110, for example, as shown in and described in connection with FIG. 15.

At Step 1018, the control system 300 is configured and operating to draw a vacuum on the first inflatable compartment 108 and the envelope 200 and to discharge air drawn from the first inflatable compartment 108 and the envelope 200 under pressure to the second inflatable compartment 110 to thereby fully inflate the second inflatable compartment 110, for example, as shown in and described in connection with FIG. 16.

At Step 1020, the control system 300 is configured and operating to hold the second inflatable compartment 110 at the predetermined inflation pressure, for example, as shown in and described in connection with FIG. 16.

At Step 1022, the control system 300 is configured and operating to mitigate leakage from the second inflatable compartment 110 into the first inflatable compartment 108 or the envelope 200, for example, as shown in and described in connection with FIG. 17.

At Step 1024, the control system 300 is configured and operating to vent pressurized air from the second inflatable compartment 110 to the first inflatable compartment 108 and to equalize air pressure in the first inflatable compartment 108 and the second inflatable compartment 110, thereby partially inflating the first inflatable compartment 108, for example, as shown in and described in connection with FIG. 18.

At Step 1026, the control system 300 is configured and operating to withdraw air from the second inflatable compartment 110 and discharge the air withdrawn from the second inflatable compartment 110 under pressure to the first inflatable compartment 108 to thereby more fully inflate the first inflatable compartment 108, for example, as shown in and described in connection with FIG. 19.

At Step 1028, the control system 300 is configured and operating to briefly withdraw makeup air from the environment E and discharge the air withdrawn from the environment E under pressure to the first inflatable compartment 108 to thereby more fully inflate the first inflatable compartment 108, for example, as shown in and described in connection with FIG. 20.

At Step 1030, the control system 300 is configured and operating to draw a vacuum on the second inflatable compartment 110 and the envelope 200 and to discharge air drawn from the second inflatable compartment 110 and the envelope 200 under pressure to the first inflatable compartment 108 to thereby fully inflate the first inflatable compartment 108, for example, as shown in and described in connection with FIG. 21.

At Step 1032, the control system 300 is configured and operating to hold the second inflatable compartment 110 at the predetermined inflation pressure, for example, as shown in and described in connection with FIG. 21.

The foregoing steps or ones thereof may be repeated as desired.

The foregoing steps may be performed in the sequence described and shown. In some embodiments, some of the steps may be omitted. In some embodiments, the illustrative method may be performed using an alternative support surface overlay having first and second inflatable compartments disposed within an envelope and an alternative control system.

The foregoing description and corresponding drawings refer to one or more illustrative embodiments of a support surface overlay system according to the present disclosure. These embodiments are illustrative, and not limiting. One skilled in the art would recognize that the disclosed embodiments could be modified in numerous ways without departing from the scope of the invention as defined by the appended claims.

We claim:

1. A support surface overlay system comprising:
a therapeutic support surface overlay having a first inflatable compartment, a second inflatable compartment, and an envelope enclosing the first and second inflatable compartments, the first inflatable compartment defining a first variable air volume, the second inflatable compartment defining a second variable air volume separate from and independent of the first variable air volume, and the envelope defining a third variable air volume separate from and independent of the first variable air volume and the second variable air volume;
an envelope suction port configured for fluid connection to the third variable air volume;
a check valve configured to enable fluid flow out of the third variable air volume through the envelope suction port and to disable fluid flow into the third variable air volume through the envelope suction port; and
a control system control system configured to selectively and alternatingly inflate and deflate the first and second inflatable compartments and to concurrently evacuate fluid from an uninflated one of the first and second inflatable compartments and from the envelope, the control system comprising:
a pneumatic pump having a pump inlet port and a pump outlet port;
a first three-way control valve having a first port fluidly coupled to the pump inlet port, a second port fluidly coupled to the first variable air volume, and a third port coupled to the pump outlet port;
a second three-way control valve having a first port fluidly coupled to the pump inlet port, a second port fluidly coupled to the second variable air volume, and a third port coupled to the pump outlet port; and
an inlet flow control device having a first port fluidly coupled to an environment external to the control system and a second port fluidly coupled to the pump inlet port.

2. The support surface overlay system of claim 1 wherein, in a first operational state:
the first three-way control valve is configured to enable fluid communication between the first inflatable compartment and the pump inlet port and to disable fluid communication between the first inflatable compartment and the pump outlet port;
the second three-way control valve is configured to enable fluid communication between the second inflatable compartment and the pump inlet port and to disable fluid communication between the second inflatable compartment and the pump outlet port;
the inlet flow control device is configured to disable fluid communication between the environment and the pump inlet port; and
the pump is not running.

3. The support surface overlay system of claim 1 wherein, in a second operational state:
the first three-way control valve is configured to enable fluid communication between the first inflatable compartment and the pump inlet port and to disable fluid communication between the first inflatable compartment and the pump outlet port;
the second three-way control valve is configured to enable fluid communication between the second inflatable compartment and the pump inlet port and to disable fluid communication between the second inflatable compartment and the pump outlet port;
the inlet flow control device is configured to disable fluid communication between the environment and the pump inlet port; and
the pump is running.

4. The support surface overlay system of claim 3 wherein, in a third operational state:
the first three-way control valve is configured to enable fluid communication between the first inflatable compartment and the pump outlet port and to disable fluid communication between the first inflatable compartment and the pump inlet port; and
the second three-way control valve is configured to enable fluid communication between the second inflatable compartment and the pump inlet port and to disable fluid communication between the second inflatable compartment and the pump outlet port;
the inlet flow control device is configured to disable fluid communication between the environment and the pump inlet port; and
the pump is running.

5. The support surface overlay system of claim 1 wherein, in a fifth operational state:
the first three-way control valve is configured to enable fluid communication between the first inflatable compartment and the pump outlet port and to disable fluid communication between the first inflatable compartment and the pump inlet port; and
the second three-way control valve is configured to enable fluid communication between the second inflatable compartment and the pump inlet port and to disable fluid communication between the second inflatable compartment and the pump outlet port;
the inlet flow control device is configured to disable fluid communication between the environment and the pump inlet port; and
the pump is not running.

6. The support surface overlay system of claim 1 further comprising a first pressure sensor configured to determine fluid pressure in the first inflatable compartment wherein, in a sixth operational state:
the first three-way control valve is configured to enable fluid communication between the first inflatable compartment and the pump outlet port and to disable fluid communication between the first inflatable compartment and the pump inlet port; and
the second three-way control valve is configured to enable fluid communication between the second inflatable compartment and the pump inlet port and to disable fluid communication between the second inflatable compartment and the pump outlet port;
the inlet flow control device is configured to disable fluid communication between the environment and the pump inlet port; and
the pump cycles between running and not running states in order to maintain the pressure in the first inflatable compartment as determined by the first pressure sensor at a first desired pressure.

7. The support surface overlay system of claim 1 wherein, in a seventh operational state:
the first three-way control valve is configured to enable fluid communication between the first inflatable compartment and the pump inlet port and to disable fluid communication between the first inflatable compartment and the pump outlet port; and
the second three-way control valve is configured to enable fluid communication between the second inflatable compartment and the pump inlet port and to disable fluid communication between the second inflatable compartment and the pump outlet port;
the inlet flow control device is configured to disable fluid communication between the environment and the pump inlet port; and
the pump is not running.

8. The support surface overlay system of claim 1 wherein, in an eighth operational state:
the first three-way control valve is configured to enable fluid communication between the first inflatable compartment and the pump inlet port and to disable fluid communication between the first inflatable compartment and the pump outlet port; and
the second three-way control valve is configured to enable fluid communication between the second inflatable compartment and the pump outlet port and to disable fluid communication between the second inflatable compartment and the pump inlet port;
the inlet flow control device is configured to disable fluid communication between the environment and the pump inlet port; and
the pump is running.

9. The control system of claim 1 wherein, in a ninth operational state:
the first three-way control valve is configured to enable fluid communication between the first inflatable compartment and the pump inlet port and to disable fluid communication between the first inflatable compartment and the pump outlet port; and
the second three-way control valve is configured to enable fluid communication between the second inflatable compartment and the pump outlet port and to disable fluid communication between the second inflatable compartment and the pump inlet port;
the inlet flow control device is configured to enable fluid communication between the environment and the pump inlet port; and
the pump is running.

10. The support surface overlay system of claim 1 further comprising a second pressure sensor configured to determine fluid pressure in the first inflatable compartment wherein, in an eleventh operational state:
the first three-way control valve is configured to enable fluid communication between the first inflatable compartment and the pump inlet port and to disable fluid communication between the first inflatable compartment and the pump outlet port; and
the second three-way control valve is configured to enable fluid communication between the second inflatable compartment and the pump outlet port and to disable fluid communication between the second inflatable compartment and the pump inlet port;
the inlet flow control device is configured to disable fluid communication between the environment and the pump inlet port; and
the pump cycles between running and not running states in order to maintain the pressure in the second inflatable compartment as determined by the second pressure sensor at a second desired pressure.

11. The support surface overlay system of claim 1 wherein, in a thirteenth operational state:
the first three-way control valve is configured to enable fluid communication between the first inflatable compartment and the pump outlet port and to disable fluid communication between the first inflatable compartment and the pump inlet port; and
the second three-way control valve is configured to enable fluid communication between the second inflatable compartment and the pump inlet port and to disable fluid communication between the second inflatable compartment and the pump outlet port;
the inlet flow control device is configured to disable fluid communication between the environment and the pump inlet port; and
the pump is running.

12. The support surface overlay system of claim 1 wherein, in a fourteenth operational state:
the first three-way control valve is configured to enable fluid communication between the first inflatable compartment and the pump outlet port and to disable fluid communication between the first inflatable compartment and the pump inlet port; and
the second three-way control valve is configured to enable fluid communication between the second inflatable compartment and the pump inlet port and to disable fluid communication between the second inflatable compartment and the pump outlet port;
the inlet flow control device is configured to enable fluid communication between the environment and the pump inlet port; and
the pump is running.

13. A control system for use with a therapeutic support surface overlay having a first inflatable compartment, a second inflatable compartment, and an envelope enclosing the first and second inflatable compartments, the first inflatable compartment defining a first variable air volume, the second inflatable compartment defining a second variable air volume separate from and independent of the first variable air volume, and the envelope defining a third variable air volume separate from and independent of the first variable air volume and the second variable air volume, the control system comprising:
a pneumatic pump having a pump inlet port and a pump outlet port;
a first three-way control valve having a first port fluidly coupled to the pump inlet port, a second port configured to be fluidly coupled to the first variable air volume, and a third port coupled to the pump outlet port;
a second three-way control valve having a first port fluidly coupled to the pump inlet port, a second port configured to be fluidly coupled to the second variable air volume, and a third port coupled to the pump outlet port;
an inlet flow control device having a first port fluidly coupled to an environment external to the control system and a second port fluidly coupled to the pump inlet port;
an envelope suction port configured for fluid connection to the third variable air volume; and
a check valve configured to enable fluid flow out of the third variable air volume through the envelope suction port and to disable fluid flow into the third variable air volume through the envelope suction port.

14. A method of operating a therapeutic support surface overlay having a first inflatable compartment, a second inflatable compartment, and an envelope enclosing the first and second inflatable compartments, the first inflatable compartment defining a first variable air volume, the second inflatable compartment defining a second variable air volume separate from and independent of the first variable air volume, and the envelope defining a third variable air volume separate from and independent of the first variable air volume and the second variable air volume, the method comprising:
providing the therapeutic support surface overlay;
providing a control system configured to selectively and alternatingly inflate and deflate the first and second inflatable compartments and to concurrently evacuate fluid from an uninflated one of the first and second inflatable compartments and from the envelope; and
operating the control system to selectively and alternatingly inflate and deflate the first and second inflatable compartments and to concurrently evacuate fluid from an uninflated one of the first and second inflatable compartments and from the envelope.
